(19) United States
(12) Patent Application Publication
(10) Pub. No.: US 2009/0308940 A1
(43) Pub. Date: Dec. 17, 2009

(54) ADJUSTING MEANS

(75) Inventors: John William Green, Hamilton (NZ); Ian Moran, Hamilton (NZ)

Correspondence Address: NIXON PEABODY, LLP, 401 9TH STREET, NW, SUITE 900, WASHINGTON, DC, 20004-2128, US

(73) Assignee: GREENS INDUSTRIES LIMITED, Hamilton (NZ)

(21) Appl. No.: 12/160,747

(22) PCT Filed: Jan. 5, 2007
(86) PCT No.: PCT/NZ2007/000002

§ 371 Date: Jan. 6, 2009

(30) Foreign Application Priority Data
Jan. 11, 2006 (NZ) 544598

(51) Int. Cl. G05D 23/13

(52) U.S. Cl. 236/12.11

(57) ABSTRACT

A single lever valve for mixing hot and cold liquids has a mixer which can internally impose an upper limit on the temperature of any liquid emerging from it. The means used may enable the upper limit to be changed by exchange of a component so that the mixer can be used in any location in an installation even though different locations might have different upper limit requirements. The mixer may take the form of a cartridge able to be exchanged with an existing cartridge to convert an “unsafe” mixer to a “safe” one. An adjustment means is provide enabling the upper temperature limit cut-off to be accurately set—even before assembly of the mixer.

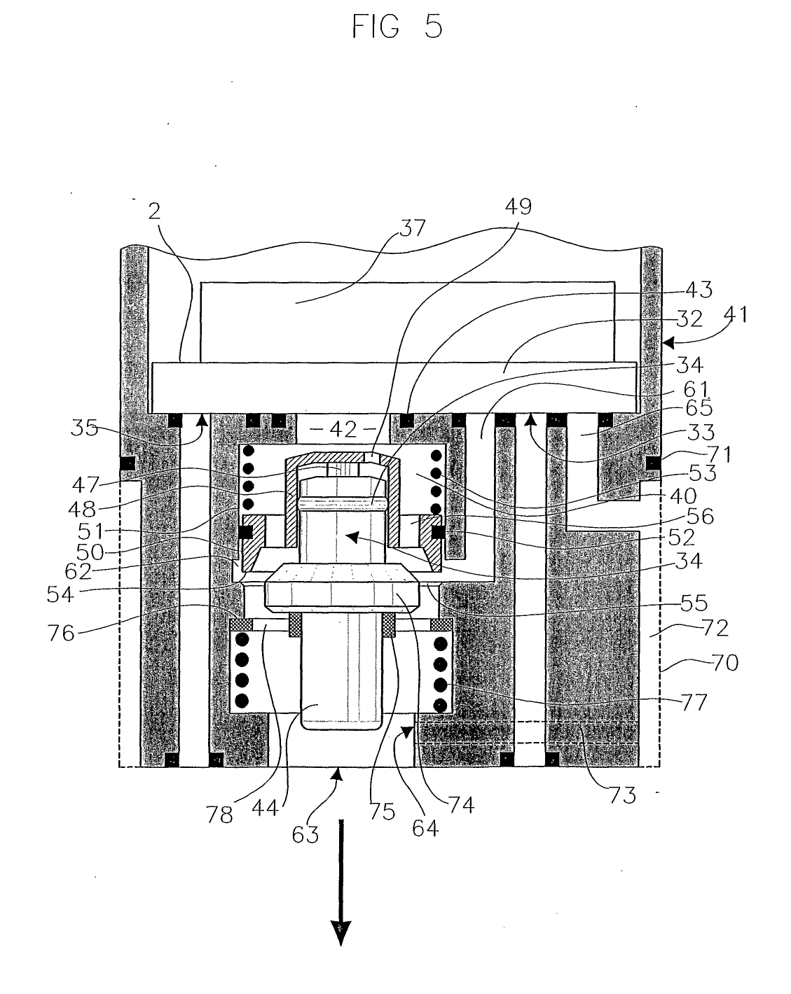

In our international patent application PCT/NZ2004/000225, published under WO2005/028930 on 31 Mar. 2005, we described a temperature limiting device applicable to single lever valves for mixing hot and cold liquids. This invention relates to an improvement to the construction which is shown in FIG. 5 of that specification. The definitions in that specification are applicable to this and it is intended that the whole contents of that specification be treated as if repeated in this in order to enable an understanding of the context of the present invention.

### BACKGROUND

### Prior Art and Description of the Drawings

Referring to the aforementioned FIG. 5, a copy of which is incorporated with this specification, the temperature sensing device 34 was seated on a support member 75 and optional biasing by spring 77 prevented any damaged to or from a highly heated temperature sensing device. There was no means of readily adjusting the temperature at which complete cut-off of the hot liquid inlet passages occurred. The accuracy of the temperature sensing device was critical.

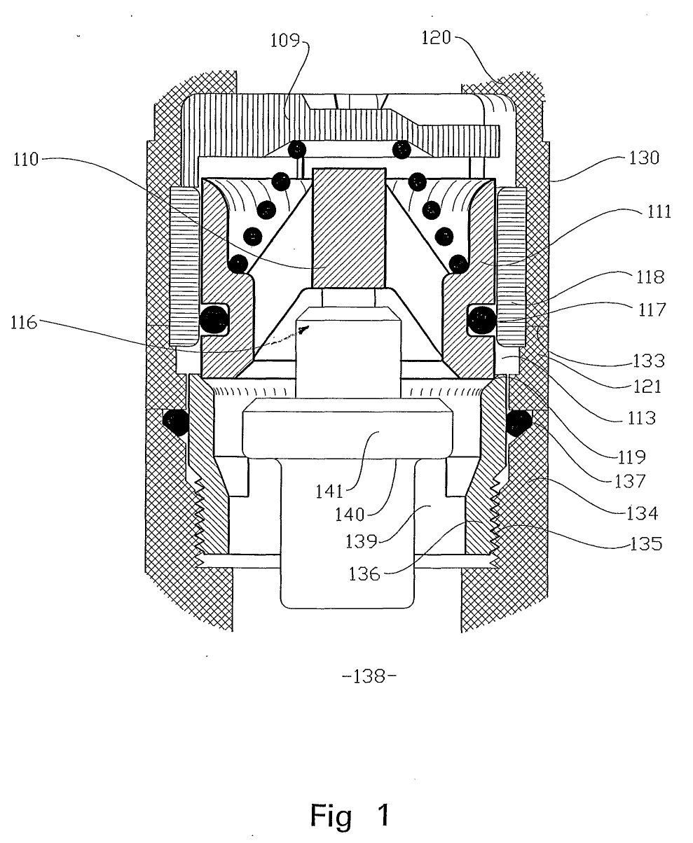

The present invention will shortly be described with reference to FIG. 1 which is a schematic cross-sectional view of modifications to the lower part of the FIG. 5 arrangement.

### STATEMENT OF INVENTION

The present invention consists in an improvement to the inventions claimed in PCT/NZ2004/000225 (WO 2005/028930) in that the convergence space has an axis and there are adjustment means enabling the position of the temperature sensing device to be axially adjusted by axially moving an insert supporting the temperature sensing device, causing also a seat for closure of the first cold liquid inlet to move to or fro along the axis.

### BEST MODE OF CARRYING OUT THE INVENTION

A first case portion 120 of a cartridge houses inserted portion 109. A wall insert 118 is closely mated to a piston 111 and O-ring 117. During assembly once the wall insert 118 is also in position in the first case portion 120 a second case portion 121 of the cartridge is immediately ultrasonically welded or otherwise fastened to the first portion 120 at the annular joint 133. The novel operation of the piston is described in our concurrently filed sister patent specification which it is intended be read and treated as if incorporated herein to enable a better understanding of some aspects of FIG. 1. However this invention is not limited to the precise construction shown in FIG. 1. It also has direct use to the construction shown in FIG. 5 where hot liquid enters the convergence space via entry 42 as opposed to entry at the upper sides of a cylindrical convergence chamber as shown in FIG. 1.

A third case portion 134 has an internal female thread 135 into which is screwed an adjusting insert or cylinder 136 with a mating male thread. An O-ring 137 prevents leakage of cold liquid from first cold liquid inlet passage 113 to the outlet 138 of the device via the threads 135. It also imposes frictional resistance so the cylinder 136 remains held in a set position during use after initial adjustment. It also stops leakage across the joint between second and third case portions 121 and 134.

The threaded cylinder 136 has ribs 139 of which there might be perhaps six radially extending inwardly to locate and support the temperature sensing device 116. Upper surfaces of the ribs 139 bear on the annular undersurface 140 of the collar 141.

The next assembly step is for the piston 111 and the temperature sensing device 116 etc to be installed in the first and second case portions 120, 121. Then the components with the adjusting cylinder 136 are placed in position. There may be temporary clips (not shown) recessed in the outside wall 130 of the cartridge loosely holding the components together without undue compression of O-ring 137 until final installation of the cartridge in a valve body is performed.

The adjustment provided by the threaded insert or cylinder 136 enables the axial height of the seal at 119 to be altered. When the cylinder 136 is screwed up towards the portion 109 it shortens the distance the piston 111 travels to effect hot liquid shut-off. Thus shut-off occurs at a lower temperature. In practice the cylinder might be adjusted within its third case portion 134 when fitted to a false or temporary upper combination so there is a tested shut off at the maximum desired temperature.

| Ref | |
|---|---|
| 109 | portion |
| 110 | cap |
| 111 | piston |
| 112 | |
| 113 | First cold liquid inlet passage |
| 114 | |
| 115 | |
| 116 | temperature sensing device |
| 117 | O-ring |
| 118 | Wall insert |
| 119 | seal |
| 120 | First case portion |
| 121 | Second case portion |
| 122 | |
| 123 | |
| 124 | |
| 125 | |
| 126 | |
| 127 | |
| 128 | |
| 129 | |
| 130 | Outside wall |
| 131 | |
| 132 | |
| 133 | Annular joint |
| 134 | Third case portion |
| 135 | female thread |
| 136 | adjusting cylinder |
| 137 | O-ring |
| 138 | outlet |
| 139 | ribs |
| 140 | annular undersurface |
| 141 | collar |

1. A device for mixing and regulating the output temperature of a hot liquid and a cold liquid, which includes:
a mixing chamber
a hot liquid entry port into said chamber
a cold liquid entry port into said chamber
an outlet from said chamber
an outlet passage from the device which communicates with said chamber outlet
mix proportioning [flow control] means within said chamber able to alter the proportions of hot and cold Liquids admitted through said entry ports into said chamber at any rate of combined output flow
a temperature sensing device adapted to sense the temperature of the output of the mixed liquids from the chamber and to control the mix proportioning means so that the output temperature at all output flow rates from the chamber can never exceed, except for a small tolerance for a small time, a selected maximum
a second cold liquid entry port into the output passage of the device downstream from where the temperature of the output flow from the chamber is sensed
characterised in that
the temperature sensing device is supported by adjustment means which co-act with the device to enable relative displacement of the temperature sensing device towards or away from the hot liquid entry port.

2. A device as claimed in claim 1 wherein the adjustment means includes a threaded insert which includes a seat enabling closure of the first cold liquid inlet port, rotation of the threaded insert around mating threads in the device in use causing movement of the temperature sensing device and said seat towards or away from the hot liquid entry port.

3. A device as claimed in claim 2 wherein the adjustment means bears upwardly on a collar around a housing of the temperature sensing device and the threads of the insert mate with those of a part of the device readily detachable from the part or parts containing the hot liquid and first cold liquid entry ports.

4. A device as claimed in claim 3 wherein relative rotation of the insert with respect to the remainder of the device is restrained or prevented by a resilient sealing ring compressed between the insert and the remainder of the device.

5. A device as claimed in claim 4 wherein the sealing ring also seals a joint between upper and lower parts of the device.

6. A device as claimed in claim 5 wherein the sealing ring also seals the first cold liquid inlet port from the threaded regions.

7. A device as claimed in claim 1 wherein the parts other than the adjustment means and the temperature sensing device are contained in an upper portion of the device to which the lower portion of the device containing the adjustment means and the temperature sensing device can be offered up and secured after positioning of the insert.

8. A device as claimed in claim 7 wherein there are recessed clips able to secure the upper and lower parts together on an interim basis, once offered together, prior to final securement.

9. A device as claimed in claim 1 which includes a stationary distributing member and a movable distributing member, the stationary distributing member having ports to the movable distributing member for the supply of hot liquid and cold liquid to the movable distributing member and the movable distributing member regulates the proportions of hot and cold liquid supplied to the hot liquid entry port and to the cold liquid entry ports and the flow rates thereof, and enables complete shut-off of all flows to said ports.

10. A control device for the mixing and temperature control of hot and cold liquids which includes:
a movable distributing member,
a stationary distributing member,
a body supporting the distributing members,
sealing means to seal between parts of the movable and stationary distributing members and
in the stationary distributing member
a hot liquid inlet port
a cold liquid inlet port and
in the movable distributing member
a hot liquid transfer path and
all wholly or partly contained in the body, or all wholly or partly contained in the movable distributing member, or all wholly or partly contained in the stationary distributing member
a convergence space
a hot liquid inlet passage communicating with said hot liquid transfer path and with said convergence space
a first cold liquid inlet passage communicating with said cold liquid transfer path and with said convergence space
an outlet from said convergence space flow
regulating means within the convergence space capable of regulating the flow of hot and cold liquids entering said convergence space by progressively opening the hot liquid inlet passage while progressively closing the first cold liquid inlet passage and vice versa and capable of effecting complete closure of said hot liquid inlet passage
a temperature sensing device which controls the operation of the flow regulating means
in said outlet, a temperature sensing portion of said temperature sensing device
a second cold liquid inlet passage communicating with said cold liquid transfer path and with said outlet substantially downstream of said temperature sensing portion
and
the movable distributing member being movable to each of the following positions:
where the hot liquid inlet port communicates with the hot liquid transfer path which communicates with the hot liquid inlet passage and at the same time the cold liquid inlet port communicates with the cold liquid transfer path which communicates with the first cold liquid inlet passage; or
where the hot liquid inlet port communicates with the hot liquid transfer path which communicates with the hot liquid inlet passage and at the same time the cold liquid inlet port communicates with the cold liquid transfer path which communicates with the first cold liquid inlet passage and the cold liquid transfer path also communicates with the second cold liquid inlet passage; or
where the hot liquid inlet port and the cold liquid inlet port do not communicate with each other and block communication from both said hot liquid inlet port and said cold liquid inlet port with any said passage
characterised In that
the temperature sensing device is supported by an adjustment means which co-acts adjustably with the body to enable relative displacement of the temperature sensing device towards or away from the hot liquid inlet passage o while at the same time not affecting the capacity of, or adjustment of, the flow regulating means to close the first cold liquid inlet passage.

11. A device as claimed in claim 10 wherein the adjustment means includes a threaded insert in the body, the insert including a seat forming parts 5 of the means enabling closure of the first cold liquid inlet passage, rotation of the threaded insert within mating threads in the body causing movement of the temperature sensing device and said seat towards or away from the hot liquid inlet passage in use.

12. A device as claimed in claim 11 wherein the temperature sensing device has a housing and there is a collar surrounding the housing and part of the insert bears upwardly on the collar while the seat lies above the collar.

13. A device as claimed in claim 12 wherein relative rotation of the insert 5 with respect to the body is restrained or prevented by means of a resilient sealing ring compressed between the insert and the body.

14. A device as claimed in claim 13 wherein the sealing ring also seals the threaded region from the first cold liquid inlet passage.

15. A control device for the mixing and temperature control of hot and cold liquids which includes:
a movable distributing member,
a stationary distributing member,
a body supporting the distributing members,
sealing means to seal between parts of the movable and stationary distributing members and
in the stationary distributing member
a hot liquid inlet port
a cold liquid inlet port
a hot liquid outlet port
a first cold liquid outlet port
a second cold liquid outlet port and
in the movable distributing member
a hot liquid transfer cavity
a cold liquid transfer cavity and in the body
a convergence space
a hot liquid inlet passage communicating with said hot liquid outlet port and with said convergence space
a first cold liquid inlet passage communicating with said first cold liquid outlet port and with said convergence space
an outlet from said convergence space
flow regulating means within the convergence space capable of regulating the flow of hot and cold liquids entering said convergence space by progressively opening the hot liquid inlet passage while progressively closing the first cold liquid inlet passage and vice versa and capable of effecting complete closure of said hot liquid inlet passage
a temperature sensing device which controls the operation of the flow regulating means
in said outlet, a temperature sensing portion of said temperature sensing device
a second cold liquid inlet passage communicating with said second cold liquid outlet port and with said outlet substantially downstream of said temperature sensing portion and
the movable distributing member being movable to each of the following positions:
where the hot liquid inlet port communicates with the hot liquid transfer cavity which communicates with the hot liquid outlet port and at the same time the cold liquid inlet port communicates with the cold liquid transfer cavity which communicates with the first cold liquid outlet port; or
where the hot liquid inlet port communicates with the hot liquid transfer cavity which communicates with the hot liquid outlet port and at the same time the cold liquid inlet port communicates with the cold liquid transfer cavity which communicates with the first cold liquid outlet port and the cold liquid transfer cavity also communicates with the second cold liquid outlet port; or
where the hot liquid inlet port and the cold liquid inlet port do not communicate with any outlet port
characterised in that
the temperature sensing device is supported by an adjustment means which co-acts adjustably with the body to enable relative displacement of the temperature sensing device towards or away from the hot liquid inlet port while at the same time not affecting the capacity of the flow regulating means to close the first cold liquid inlet port.

16. A control device as claimed in claim 15 wherein the adjustment means includes a threaded insert in the body, the insert including a seat forming parts of the means enabling closure of the first cold liquid inlet port, rotation of the threaded insert within mating threads in the body causing movement of the temperature sensing device and said seat towards or away from the hot liquid inlet port in use.

17. A control device as claimed in claim 16 wherein the temperature sensing device has a housing and there is a collar surrounding the housing and part of the insert bears upwardly on the collar while the seat lies above the collar.

18. A control device as claimed in claim 17 wherein relative rotation of the insert with respect to the body is restrained or prevented by means of a resilient sealing ring compressed between the insert and the body.

19. A control device as claimed in claim 13 wherein the sealing ring also seals the threaded region from the first cold liquid inlet port.

20. A control device as claimed in claim 15 wherein the convergence space has an axis, a cylindrical wall coaxial with said axis and said flow regulating means includes a movable member capable of moving within the cylindrical chamber defined by said cylindrical wall.

21. A control device as claimed in claim 20 wherein said movable member comprises a partition across said cylindrical wall, sealingly slidable to and fro in axial directions, and there is an orifice through said partition which may offer communication between said hot and cold inlet passages.

22. A control device as claimed in claim 21 wherein said first cold liquid inlet passage communicates with said convergence space via said cylindrical wall and said partition includes a cylindrical skirt which may be positioned over said first cold liquid inlet passage.

23. A control device as claimed in claim 22 wherein said skirt may be positioned over said first cold liquid inlet passage to a position where said passage is completely closed against a seat forming part of said adjustment means so that, in use, no cold liquid can then enter said convergence space.

24. A control device as claimed in claim 23 wherein said hot liquid inlet passage communicates with said convergence space at or adjacent an end of said cylindrical chamber via a chamber inlet port.

25. A control device as claimed in claim 24 wherein said first cold liquid inlet passage includes a recess around said cylindrical wall lying substantially between planes which are normal to said cylindrical wall axis.

26. A control device as claimed in claim 25 wherein said cylindrical wall axis is parallel to an axis about which both said movable distributing member and said insert may be rotated.

27. A control device as claimed in claim 20 when dependent on claim 20 wherein said temperature sensing device is arranged within said body, in use, to expand on sensed liquid temperature increase and contract on sensed liquid temperature decrease, in axial directions.

28. A control device as claimed in claim 27 wherein said temperature sensing device includes a housing and a piston capable of being moved axially to and fro with respect to said housing, coaxially with said cylindrical wall axis.

29. A control device as claimed in claim 15 wherein the movable distributing member and stationary distributing member are ceramic discs.

30. A device as claimed in claim 15 wherein the device is in the form a cartridge for a valve.

31. A device as claimed in claim 1 wherein the device is a valve and includes a single operating lever.
